(19) United States
(12) Patent Application Publication
(10) Pub. No.: US 2008/0299372 A1
(43) Pub. Date: Dec. 4, 2008

(54) Extra strength polymer composite construction material and process for making the same

(76) Inventors: Gary Stidham, St. Petersburg, FL (US); Christopher Brown, Merritt Island, FL (US); Marvin Peplow, Bartlett, IL (US)

Correspondence Address: Clifford Kraft, 320 Robin Hill Dr., Naperville, IL, 60540, US

(21) Appl. No.: 11/899,745

(22) Filed: Sep. 8, 2007

Related U.S. Application Data
(60) Provisional application No. 60/933,035, filed on Jun. 4, 2007.

(51) Int. Cl. B32B 5/02; B32B 27/08; B32B 5/00; B29C 41/22; B32B 3/12

(52) U.S. Cl. 428/220; 428/422.8; 428/339; 428/314.4; 428/317.9; 156/243

(57) ABSTRACT

A composite material that can be economically produced without the emission of VOCs that is extremely strong and is bonded at the molecular level. An embodiment of the present invention can be a composite of two or more layers with a first layer made from an aliphatic polymer like a polyurea and a resin like an isocyanate resin. A third layer of strengthened urethane foam can optionally be used. The composite material can be made up of layers of material with a first layer of a polyurea polymer and the second layer of an isocyanate resin chemically bonded to the first layer. The first layer can have a glossy outer surface if desired. The second layer can also optionally contain carbon fibers, nano-tubes or basalt fibers for extra strength if desired. The material can be produced in sheets of from 8 to 12 feet wide and from 40 to 60 feet long. Carbon fibers, carbon nano-tubes and Basalt fibers can be added for strength and rigidity. The optional urethane foam layer can contain carbon fibers, carbon nano-tubes or basalt or other fibers for strengthening.

This application is related to and claims priority from U.S. Provisional Patent application No. 60/933,035 filed Jun. 4, 2007. Application No. 60/933,035 is hereby incorporated by reference.

### BACKGROUND

1. Field of the Invention

The present invention relates general to the field of polymer construction materials and more particularly to an extra strength composite polymer construction material.

2. Description of the Prior Art

Several types of composite materials are known and used in the construction of vehicles like house trailers, boats, trucks and in the construction of buildings. Many of these materials are plastics (polymers). A major problem with current composite polymer materials is that they are not very strong and they delaminate. Many construction uses for such materials expose them to severe conditions such as ultra-violet radiation from sunlight, salt air or salt spray, dry conditions in dryer climates and a tremendous range of ambient temperatures. Exposure to such environmental extremes can be very hard on current materials. Delamination can occur because the composite interfaces are no bonded at the chemical (molecular) level, but rather are only mechanically bonded. Another type of material in common use is fiberglass. However, fiberglass, and many of the other materials in common use, are expensive and slow to manufacture and have production problems with VOC emissions (volatile organics) and hence, production facilities must be strictly controlled according to governmental regulations with expensive equipment to remove VOCs and not let them escape into the environment.

It would be advantageous to have an extra-strong composite material that could be molded economically into large uniform sheets with no VOC emissions that would be extremely strong and that would be chemically bonded at the composite interface rather than mechanically bonded. This material could replace fiberglass or polymers used in construction of trailers, boats, bathtubs, showers and many other applications.

### SUMMARY OF THE INVENTION

The present invention relates to a composite material that can be economically produced without the emission of VOCs that is extremely strong and is bonded at the molecular level. An embodiment of the present invention can be a composite of two, three or more layers of material with a first layer being a polyurea polymer and the second layer of an isocyanate resin chemically bonded to the first layer. An optional third layer can be an open or closed cell urethane. The first layer can be from around 10-35 mil thick with around 10-20 mil being preferred, while the second layer can be from around 2.7 mm thick up to any desired thickness. A common thickness might be ⅛ inch, ¼ inch or other size. The third layer can be a foam of any desired thickness. The first layer can have a glossy outer surface if desired or any other finish such as a non-skid finish. The second and third layers, and other optional layers, can optionally contain carbon fibers, carbon nano-tubes or other strengtheners for extra strength if desired. The material can be produced in sheets of from 8 to 12 feet wide and from 40 to 60 feet long or any other convenient size.

### DESCRIPTION OF THE FIGURES

Refer now to the following drawings to better understand the present invention:

FIG. 1 shows a perspective view of a sheet of composite material according to an embodiment of the present invention. A cross section can be seen.

FIG. 2 shows schematically a production process that can be used to produce various embodiments of the present invention.

FIG. 3 shows an embodiment of the present invention with a third layer.

Several drawings and illustrations have been presented to aid in understanding the present invention. The scope of the present invention is not limited to the figures.

### DESCRIPTION OF THE INVENTION

The present invention relates to a two, three or more layer composite. The first layer can be a hard white or colored layer made from an aliphatic polyurea plastic that can be formed in a mold. A preferred product for this layer is FUTURA-THANE® manufactured by ITW Devcon FuTura Coatings of St. Louis, Mo. This polyurea does not emit VOCs either during storage or during the mixing and setting process. It also does not out-gas VOCs after setting. It produces a very strong layer with a high-gloss surface. In the present invention, the polyurea can be mixed and hot sprayed into modes that produce pieces in standard widths such as 8 or 10 feet with lengths of around 40 to 50 feet or longer. While these are preferred dimensions, any sizes of pieces are within the scope of the present invention. Further coating or finishing (such as non-skid) can be put on or performed on this layer to product a finish product.

The polyurea is normally supplied in two components that are mixed in a 1:1 ratio. The material is mixed and generally sprayed into the molds at a temperature of between around 135 degrees F. to 170 degrees F. The materials are normally pre-heated to around 75-90 degrees F. prior to use. The preferred thickness of the polyurea layer can be around 22 mil. however, any other thickness is within the scope of the present invention.

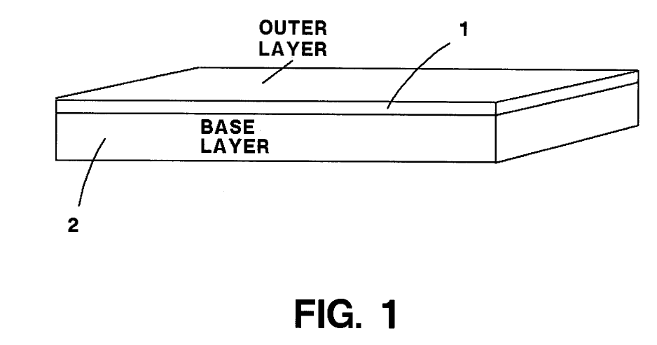

The second or generally thicker base layer of the composite can be made from an isocyanate resin (polyurethane). The preferred product is Elastocast® 70736R Resin made by Q-BASF Chemical Company of Wyandotte Mich. This product is also supplied as an A-B mix where the mix ratio is approximately 1:1. The resin is normally mixed and applied by spraying it on top of the polyurea in the same mold. The preferred application temperature is around 110-120 degrees F. The layer can be sprayed to a desired thickness in one or preferably two spray passes down and back. The preferred time to apply the second layer is between 30 seconds and one minute after the first layer. The second layer chemically bonds to the first layer. FIG. 1 shows a cross-section of an embodiment of the present invention. The outer layer 1 is chemically bonded to the base layer 2.

Extra strength can be achieved by mixing carbon fibers, carbon nano-tubes or any other fiber into the resin before spraying. Carbon nanotubes can be purchased as either thick or thin wall and can be obtained in several different sizes. Carbon fibers can be purchased in bulk and simply added to the mix in a proportion of from 0% up to around 2.5%, with 0.5% being the preferred percentage. A typical carbon fiber can be purchased from Pyrograph Products of Cedarville Ohio. The carbon fibers add stiffness and screw retention to the product.

In addition to or instead of carbon fibers, a volcanic material known as Basalt fibers can also be added. Basalt fibers can be purchased in the form of woven meshes. Various meshes can be used in the present invention to increase strength and rigidity. The final product using only Basalt fibers can be as much as 20% stronger than fiberglass of the same thickness. Basalt fiber is made from extremely fine fibers of basalt which is composed of the minerals plagioclase, pyroxene and olivine. Basalt fibers are manufactured by heating and extruding quarried basalt rock through nozzles. Basalt is inorganic and introduces no volatile organics into the process. One of the advantages of the present invention is achieving the strength without the production of harmful VOCs.

Another advantage of the base layer material of the present invention described in the paragraphs above is the ability to spray the material to a particular thickness, allow it to set, and then immediately, or possibly much later, spray more material on to a second thickness. The second spraying generally is hot enough to make a chemical bond with the first spraying to form a homogeneous and continuous layer. The technique of multiple spraying is particularly useful for spraying up molds with curvature where a single spraying operation to the desired thickness would cause running. For example, a mold can be sprayed in successive layers 25-50 mil at a time until the desired final thickness is achieved.

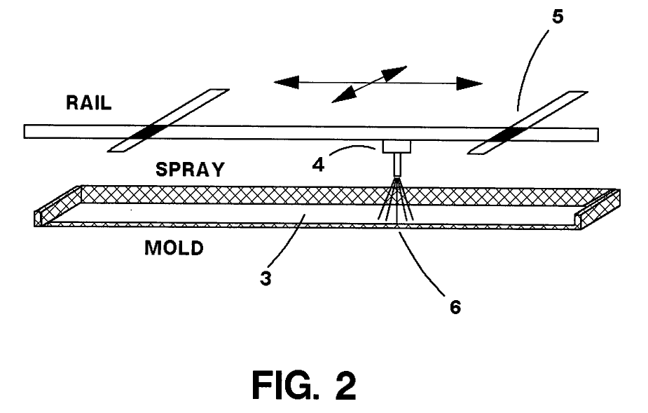

A particular production facility for the composite sheets of the present invention can make one piece in around 6 minutes using 3-4 passes without any VOC production. A typical plant could run 6 molds with two of the molds be de-molded. It is estimated that around 12 million square feet of the material could be produces in three shifts. To manufacture the material, the polyurea can be sprayed into a mold of the proper width and length in one or more passes. The polyurea can be allowed to begin to set up for between around 30 to 60 seconds. The isocyanate layer can then be sprayed in one or more passes (preferably 3-4 passes). After complete set-up, the piece can be removed from the mold and the process repeated. It is generally possible to run an assembly operation with around 6 molds, with 2 molds being sprayed with polyurea, 2 molds being sprayed with isocyanate resin and 2 molds being de-molded. The process as outlined in the present invention does not produce dangerous VOCs and therefore does not require special licenses or VOC containment equipment. As previously discussed, carbon fibers, plain or woven Basalt fibers and other materials can be added to the base layer for extra strength and rigidity. FIG. 2 shows a process of spraying a large sheet in a mold 3 with a moving nozzle 6. that runs on a set of rails 5. When more complex shapes are desired such as, for example, a bathtub or shower, the walls can each be sprayed up separately as well as the floor. As previously stated, the present invention allows multiple sprayings to bond chemically.

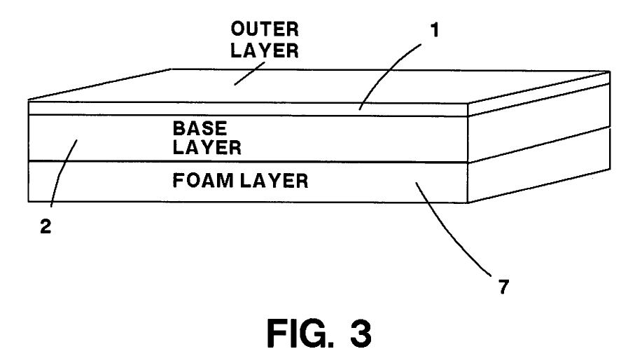

It is possible to put a third layer, or more layers, on the product of the present invention. FIG. 3 shows an embodiment with a third layer 7 of urethane foam that can be strengthened by adding carbon fibers, carbon nano-tubes or any of the other fibers mentioned. Using a fill rate of carbon fiber from around 0.1% up to around 2.5%, any open or closed cell urethane foam can be significantly strengthened. This is so because no water is introduced. For example, filling 2.0% with carbon fibers, a 20 lb. foam can achieve the compression strength normally found in a 40 lb. foam.

The several layers in FIG. 3 are a surface layer 1, an elastomer layer 2 and a foam layer 7. Each layer can contain carbon fibers or other strengthening material and can vary in thickness to desired dimensions. A particular embodiment might be a hard, shinny white or colored surface layer 1, a carbon fiber filled elastomer layer 2 and a carbon fiber filled urethane foam layer 3. The first layer could be around 22 mil., the second layer could be around ⅛ inch, and layer 3 could be around ¼ inch. These dimensions are simply for the purpose of illustration. Any dimensions in any layer are within the scope of the present invention.

While carbon fibers, carbon nano-tubes or basalt fibers have been used in the present invention for strengthening the various layers, any fiber or any strengthening method, material or means is within the scope of the present invention.

Several descriptions and illustrations have been presented to better aid in understanding the present invention. One of skill in the art will realize that there exist numerous changes and variations without departing from the spirit of the invention. Each of these changes and variations is within the scope of the present invention.

We claim:

1. A composite material comprising two layers of material:
a first layer of a polyurea;
a second layer of an isocyanate resin chemically bonded to said first layer,
wherein said second layer strengthened by filling with fibers.

2. The composite material of claim 1 wherein said first layer is around 10-30 mil thick.

3. The composite material of claim 1 wherein said second layer is around 2 mm to ½ inch thick.

4. The composite material of claim 1 wherein said first layer has a glossy outer surface.

5. The composite material of claim 1 wherein said second filling is with carbon fibers, carbon nano-tubes or basalt fibers.

6. The composite material of claim 1 produced in sheets of from 8 to 12 feet wide.

7. The composite material of claim 1 produced in sheets of from 40 to 60 feet long.

8. The composite material of claim 1 further comprising a third layer of open or closed cell urethane filled with carbon fibers, carbon nano-tubes or basalt fibers.

9. A composite material comprising two layers of material:
a first layer of a polyurea polymer;
a second layer of an isocyanate resin chemically bonded to said first layer, said second layer containing sufficient carbon fibers to cause an increase in strength.

10. The composite material of claim 9 wherein said first layer is around 1-30 mil thick.

11. The composite material of claim 9 wherein said second layer is from around 2 mm to around ½ inch thick.

12. The composite material of claim 9 wherein said first layer has a glossy outer surface.

13. The composite material of claim 9 produced in sheets of from 8 to 12 feet wide and from 40 to 60 feet long.

14. The composite material of claim 9 further comprising at least one additional layer of a closed or open cell urethane strengthened by filling with carbon fibers, carbon nano-tubes or basalt fibers.

15. A method for manufacturing a strengthened composite material comprising the steps of:
spraying a polyurea into a flat mold of size equal to a desired finished sheet of said material;
allowing said polyurea to set up for approximately from 30 seconds to 60 seconds;
spraying an isocyanate resin layer onto said polyurea;
filling with carbon fibers, carbon nano-tubes or basalt fibers;
allowing said composite to set up;
removing said composite sheet from the mold.

16. The method of claim 15 wherein said polyurea has a thickness of approximately 10-30 mil.

17. The method of claim 15 wherein said isocyanate resin has a thickness of approximately from 2 mm to greater than ½ inch.

18. The method of claim 15 further comprising spraying a third layer of open or closed cell urethane foam strengthened with carbon fibers, carbon nano-tubes or basalt fibers on said isocyanate resin layer

19. The method of claim 15 wherein said isocyanate resin is sprayed onto said polyurea in 3 to 4 passes.

20. The method of claim 15 wherein said sheet is around 8 feet to 12 feet wide and around 40 feet to 60 feet long.

21. A method of strengthening an open cell or closed cell polyurethane foam comprising filling said foam with from 0.1% to 2.5% carbon fibers, carbon nano-tubes or basalt fibers.
